(19) United States
(12) Patent Application Publication
(10) Pub. No.: US 2022/0074135 A1
(43) Pub. Date: Mar. 10, 2022

(54) ROPE FOR AIRBORNE WIND POWER GENERATION SYSTEMS

(71) Applicant: AMPYX Power B.V., AL The Hague (NL)

(72) Inventor: Rigobert BOSMAN, AA ECHT (NL)

(21) Appl. No.: 17/416,500

(22) PCT Filed: Dec. 23, 2019
(86) PCT No.: PCT/EP2019/086948

§ 371 Date: Jun. 20, 2021

(30) Foreign Application Priority Data
Dec. 21, 2018 (EP) 18215322.1

(51) Int. Cl. D07B 1/02; H02K 7/18; F03D 5/00

(52) U.S. Cl. CPC D07B 1/025; H02K 7/183; F03D 5/00; F05B 2240/92; D07B 2205/205; D07B 2205/2014; D07B 2201/1004; D07B 2501/20

(57) ABSTRACT

The invention relates to a rope having a length LR of at least 100 m, the rope comprising synthetic filaments with a filament tenacity of at least 1.0 N/tex, characterized in that a weight fraction χ of the total weight of synthetic filaments present in the load bearing core have a length LF of 0.01 m to 0.7*L_{R}, wherein said weight fraction is at least 50 wt %. The invention further relates to an airborne wind power generation system comprising the rope as well as the use of the rope in an airborne wind power generation system wherein the length of the rope oscillates between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.

The present invention relates to a rope, which is suitable as load bearing core of the tether cable for a tethered airborne wind power generation system, the rope has a length of at least 100 m and comprises a load carrying core comprising filaments with a filament tenacity of at least 1.0 N/tex. The invention further relates to airborne wind power generation system comprising such rope. The invention relates also to a method for producing such a rope. The terms load bearing core and load carrying core used interchangeably herein.

In view of the limited resources of fossil fuels in the world and the need to reduce CO₂ emission, there is an increased demand for alternative sources of energy, in particular for energy from a renewable source. Different renewable energy systems are currently being developed using, among others, wind energy, solar energy or wave and/or tidal energy as a source.

An example of a wind energy system is a high-altitude wind energy system, which generally consists of a kite, balloon or airplane like structure that flies at an altitude of from 100 to 11,000 m, or from 100 to 5,000 m, making optimal use of the high-altitude winds. Such wind energy system is often called an airborne wind energy (AWE) system. Another example of a wind energy system is a high-altitude wind energy system, comprising a structure, which may also be referred to as air-borne unit herein, that flies at an altitude of from 100 to 11.000 m. Such structure typically makes optimal use of the high-altitude winds. Examples of such structure include as a kite, balloon, airplane, glider and a drone. Alternatively, the as air-borne unit flies at an altitude of from 200 to 2.000 m. Different systems currently exist, which include systems with a ground-based generator such as described in WO2018072890, but also systems with an air-borne, or flying, generator have been suggested. An example of such a system is described in U.S. Pat. No. 7,335,000.

The majority of the systems as described above will need a tether comprising a load bearing rope to anchor the system to an anchoring point, e.g. to the ground or to the sea bed. The systems may also need one or more cables to either transport power to the system for controlling the system, or to transport power from a generator to a ground station.

EP 3 141 513 A1 discloses tension members such as those used in elevator systems for suspension and/or driving of the elevator car and/or counterweight. U.S. Pat. No. 6,410,126 B1 discloses a unidirectional tape of carbon fibers. U.S. Pat. No. 8,689,534 B1 discloses segmented synthetic rope structures, systems, and methods. US 2014/076669 A1 discloses tension members such as those used in elevator systems for suspension and/or driving of the elevator car and/or counterweight. US 2018/044137 A1 discloses a hoisting device rope, to an elevator as and to a method of using the hoisting device rope and the elevator. WO2012013659 describes tethers combining the functionality of an anchoring member with a plurality of conductors. Wind power generation systems as for example described in WO2018072890 employ systems comprising a ground station, an airborne unit, and a tether connecting the unit with the ground station. The ground station comprises a rotatable reel for storing excess length of the tether and a power generator connected to said reel. The electric power is generated by a repeated operation cycle comprising a production phase with increasing free length of tether including flying the airborne unit away from the ground station and producing energy by driving the generator via the lift generated by the airborne unit exposed to wind, and said operation cycle further comprising a reel-in phase with decreasing free length of tether including flying the airborne unit towards said ground station. During one cycle, the tether is first subjected to high tensile loads transferring the wind energy onto the reel while the free length of the tether is continuously increased. In a second phase of the cycle, the tensile load on the tether is substantially absent while the airborne unit reduces its altitude and the free tether length is reduced.

The design of the tethers, and especially the load bearing ropes they comprise, are adjusted according to the operation altitude, the reeling system, the expected lift generated by the airborne unit as well as the maintenance intervals of the system. Typically such ropes are made of high tenacity multifilament yarns, providing highest strength at a low linear weight. Nevertheless, it was observed that tethers comprising load bearing ropes designed and manufactured according to state of the art roping technology may be subject to premature, unanticipated failures. Especially tethers employed in cyclic reeling operation as described and in particular the high-altitude tethers showed such unexplained failure behavior. The present solution is to increase the safety factor and hence substantially overdesign the ropes for tethers in such applications. The drawback is that such constructions are thicker, more expensive and reduce the efficiency of the power generation system due to increased drag and weight to lift by the airborne unit. Also the reel needs to be redesigned to accommodate for the additional tether volume.

In an attempt to overcome the above-mentioned drawbacks, the inventor designed ropes for tethered airborne wind power generation systems that comprise a weight fraction χ of the total weight of synthetic filaments present in the rope having a filament length (L_{F}) of between 0.05 m and 0.7*L_{R}, wherein said weight fraction is at least 50 wt %. The invention relates to a rope having a length L_{R} of at least 100 m, the rope comprising synthetic filaments with a filament tenacity of at least 1.0 N/tex, characterized in that a weight fraction x of the total weight of synthetic filaments present in the load bearing core have a length L_{F} in the range of 0.01 m to 0.7*L_{R}, wherein said weight fraction is at least 50 wt %. In an embodiment of the rope according to the invention the weight fraction χ of the total weight of synthetic filaments present in the load bearing core have a length L_{F} in the range of 0.05 m to 0.7*L_{R}, wherein said weight fraction is at least 50 wt %.
In an embodiment the rope according to the invention has a length L_{R} of at least 100 m, the rope comprising synthetic filaments with a filament tenacity of at least 1.0 N/tex, characterized in that a weight fraction χ of the total weight of synthetic filaments present in the load bearing core have a length L_{F} of between 0.05 m and 0.7*L_{R}, wherein said weight fraction is at least 50 wt %.
Based on his discovery, and without being bound to the theory, the inventor postulate that the unexpected failure mode of synthetic fiber ropes is related to a resonance phenomenon of longitudinal shockwaves propagating at the speed of sound through the synthetic filaments of the rope. It is suggested that under critical operation conditions, the shockwaves emitted through the rope by a vibrating airborne unit and reflected by the ground station superimpose and amplify, potentially leading to rapid deterioration and premature failure of the load bearing rope of the tether. Although the complex interaction of parameters such as vibration frequency, filament dimensions and modulus, rope dimensions and tension under operation are not fully understood, the herein provided inventive ropes show an optimized long-term operation of tethers for wind power generation systems.

The advantage is that when a rope according to the invention is employed as the load carrying core of a tether, the tether does not need to be overdesigned to show prolonged operation lifetime and/or absence of premature failure of the tether. A related advantage is hence a wind power generation system with reduced dimensions of at least the reel and tether whereby the energy efficiency of the tethered system can further be optimized. In such systems, the weight imposed by the tether on the air borne unit as well as the drag imposed on the tether by wind and weather are optimized by the low volume and low weight of the employed rope according to the invention. Furthermore, such tether is especially suited for tethered dynamic airborne wind power generation system requiring the tether to be repeatedly winched under substantial longitudinal tension and transversal compression. It was observed that tether systems comprising the rope of the invention may show a better strength efficiency and may provide longer operation of the tether before failure or preventive replacement. Therefor the safety factor that may be applied can be lowered and hence the tether comprising the rope has high strength efficiency, meaning the strength of the tether is a relatively high in relation to prior art tethers.

With tether according to the invention is meant a device comprising a rope, to be attached to an airborne unit to anchor and guide said airborne unit and transfer the wind force to and/or from the airborne unit to a reeling winch on the ground. The tether may also transfer energy and guiding signals from the ground to the airborne unit. In particular the tether may transfer energy and guiding signals from the ground station to the airborne unit. The tether comprises a rope as a load carrying core and may further comprise devices to enhance its performance, such as coatings, conductors, safety lights, sensors, etc.

A rope in the context of the present invention is an elongated body having a length much larger than its lateral dimensions of for example width and thickness or diameter. The rope to be used in accordance with the invention may have a cross-section which is circular, rounded or polygonal or combination thereof. Preferably, ropes having a circular or substantially round cross-section are used in high wind energy generation systems. By diameter of the rope is herein understood the largest distance between two opposite locations on the periphery of a cross-section of the rope. The diameter of the rope used in accordance with the invention can vary between large limits, e.g. from diameters of 5 mm or less, to diameters of up to 200 mm and even up to 300 mm. Although not a limiting factor, it was observed that efficient energy generation systems require tether with a diameter of their ropes being at least 10 mm, more preferably at least 20 mm, most preferably at least 30 mm. The upper limit for a rope diameter will strongly depend upon the wind energy transferred to the reel and might be as high as 100 mm, maybe even 150 mm or even 200 mm.

In an aspect the system according to the invention comprises a rope with a non-circular cross section, such as an oblong cross section. In an aspect the rope according to the invention has a non-circular cross section, such as an oblong cross section. For the ropes with non-circular cross-section, it is more accurate to define its size as a round rope with an equivalent diameter; that is the diameter of a circular rope of same mass per length as the non-circular rope. The diameter of a rope in general, however, is an uncertain parameter for measuring its size, because of irregular boundaries of ropes defined by the strands. A more concise size parameter is the linear density of a rope, also called titer or linear weight; which is its mass per unit length. The titer can be expressed in kg/m, but often the textile units denier (g/9000 m) or dtex (g/10000 m) are used. Diameter and titer are interrelated according to the formula d=(T/(10*ρ*v))^{0.5}, wherein T is the titer (dtex), d is the diameter (mm), ρ is the density of the filaments (kg/m³), and v is a packing factor (normally between about 0.7 and 0.9). Nevertheless, it is still customary in the rope business to express rope size in diameter values. Preferably, the rope according to the invention is a rope having an equivalent diameter of at least 20 mm, more preferably at least 30, 40, 50, or even at least 60 mm, since the advantages of the invention become more relevant the larger the rope. Largest ropes known have diameters up to about 300 mm, ropes used in airborne win energy installations typically have a diameter of up to about 200 mm, preferably of up to 100 mm.

The length of the rope (L_{R}) employed in the tether is dictated by the design of the airborne wind energy generation system and might range from lengths as low as 100 m and up to 10,000 m. For example small scale and/or off-grid installations may operate the airborne unit at altitudes of up to several hundred meters, and require tethers with ropes with lengths of at least 100 m, preferably at least 200 m and most preferably at least 300 m. In contrast commercially interesting airborne units may source the power from high-altitude winds where wind direction and speed are constant and high. Such installations may operate the airborne unit at altitudes of up to several thousand meters, and require tethers with ropes with lengths of up to 3,000 m, preferably up to 5,000 m and most preferably up to 10,000 m.

The rope according to the invention comprises at least a load bearing core, also referred to as strength member, and may comprise further elements such as a protective cover substantially situated around the strength member. Such cover may be a knitted or overbraided synthetic fiber cover and/or a protective coating.

In the present invention with primary strands is meant those strands that are the first strands that are encountered when the rope is opened up. In general these are the outermost strands of the rope, but may also include a core strand, if present. The primary strands may be made up of further secondary strands.

The strands, e.g. the primary strands, of the strength member of the rope of the invention contain yarns that comprise synthetic filaments, also referred to in the present context as high tenacity filaments. By filaments is herein understood an elongate body, the length dimension of which is much greater that the transverse dimensions of width and thickness. Accordingly, the term filament includes ribbons, strip, band, tape, and the like having regular or irregular cross-sections. The filaments may have continuous lengths, known in the art as continuous filaments, or discontinuous lengths, called in the context of the present application short fibers. Short fibers are commonly obtained by cutting or stretch-breaking filaments. A yarn for the purpose of the invention is an elongated body containing at least 2 filaments, preferably at least 25 filaments.

The synthetic filaments, present in the rope of the invention have a filament tenacity of at least 1.0 N/Tex, preferably of at least 1.2 N/Tex, more preferably at least 1.5 N/Tex, even more preferably at least 2.0 N/Tex, yet more preferably at least 2.2 N/Tex and most preferably at least 2.5 N/tex. When the high performance filaments are UHMWPE filaments, said UHMWPE filaments preferably have a tenacity of at least 1.8 N/Tex, more preferably of at least 2.5 N/Tex, even more preferably at least 3.0 N/tex and most preferably at least 3.5 N/Tex. Preferably the high performance filaments have a modulus of at least 30 N/Tex, more preferably of at least 50 N/Tex, most preferably of at least 60 N/Tex. Preferably the UHMWPE filaments have a tensile modulus of at least 50 N/Tex, more preferably of at least 80 N/Tex, most preferably of at least 100 N/Tex. N/Tex and N/tex are used interchangeably herein thus the synthetic filaments, present in the rope of the invention have a filament tenacity of at least 1.0 N/tex, preferably of at least 1.2 N/tex, more preferably at least 1.5 N/tex, even more preferably at least 2.0 N/tex, yet more preferably at least 2.2 N/tex and most preferably at least 2.5 N/tex. When the high performance filaments are UHMWPE filaments, said UHMWPE filaments preferably have a tenacity of at least 1.8 N/tex, more preferably of at least 2.5 N/tex, even more preferably at least 3.0 N/tex and most preferably at least 3.5 N/tex. Preferably the high performance filaments have a modulus of at least 30 N/tex, more preferably of at least 50 N/tex, most preferably of at least 60 N/tex. Preferably the UHMWPE filaments have a tensile modulus of at least 50 N/tex, more preferably of at least 80 N/tex, most preferably of at least 100 N/tex. In the context of the present invention tenacity and modulus are defined and determined on single filaments in accordance with ISO 5079:1995, using a Textechno's Favimat (tester no. 37074, from Textechno Herbert Stein GmbH & Co. KG, Monchengladbach, Germany) with a nominal gauge length of the filament of 50 mm, a crosshead speed of 25 mm/min and clamps with standard jaw faces (4*4 mm) manufactured from Plexiglas® of type pneumatic grip. The filament is preloaded with 0.004 N/tex at the speed of 25 mm/min. Linear density of filaments may be measured according to ASTM D1577-01. The distance between the jaws during measurements is kept at 50 mm, the monofilament being tensioned at 0.06 N/tex with a speed of 2 mm/min.

The rope of the present invention is characterized in that a weight fraction χ of the total weight of synthetic filaments present in the load bearing core have a length L_{F} of between 0.05 m and 0.7*L_{R}, wherein said weight fraction is at least 50 wt %. In other words, this means that by weight at least half of the filaments are substantially shorter than the length of the rope and hence do not form a direct connection, on filament level, between the airborne unit and the ground station. Again without been bound to the theory, the inventor considers that in such a rope construction, the transmission and reflection of the shockwave between the airborne unit and the ground station is substantially hampered and prevents detrimental amplification of the waves. By is defined weight fraction of synthetic filaments present in the rope having a length L_{F} within the defined length ranges compared to the total weight of synthetic filaments present in the rope. The upper length of the filaments forming part of the fraction χ is 0.7*L_{R}. Accordingly, if the rope has a length of 500 m, the upper limit of filament length accounting to said fraction is 350 m. Preferably the upper limit of filament length L_{F} is 0.6*L_{R}, more preferably 0.5*L_{R} and most preferably 0.4*L_{R}. Preferably the lower limit of filament length L_{F} is 0.08 m, more preferably 0.10 m even more preferably 0.12 m and most preferably 0.15 m. Lower upper limits of filaments present in the rope may increase the window of operation (load, size, rope length) in which the rope will not suffer from premature failure due to resonances. Whereas it is found that a fraction χ of 50 wt % is sufficient to be beneficial to the rope performance, it is preferred that said weight fraction is at least 70 wt %, preferably at least 90 wt % more preferably at least 95 wt % and most preferably at least 99 wt %. It is found that higher amounts of fibers not providing a direct connection between the airborne unit and the ground station further improve the resonance characteristics of the tether.

In a preferred embodiment, the rope according to the invention further comprises a polymeric matrix, preferably the yarns of the rope more preferably the filaments of the rope are at least partially coated with a polymeric matrix, whereby the polymeric matrix is preferably a thermoset or thermoplastic polymer. The polymeric matrix is preferably a thermoset or thermoplastic polymer able to form a suitable composite with the filaments, whereas silicone resins and ethylene crystalline plastomers are the preferred thermoset or thermoplastic polymers, respectively. In an aspect the rope according to the invention has a length L_{R} of at least 100 m, comprises a yarn, said yarn comprising synthetic filaments with a filament tenacity of at least 1.0 N/tex, characterized in that a weight fraction x of the total weight of synthetic filaments present in the load bearing core have a length L_{F} in the range of 0.01 m to 0.7*L_{R}, wherein said weight fraction is at least 50 wt %.

In another aspect the rope according to the invention has a length L_{R} of at least 100 m, comprises a yarn, said yarn comprising synthetic filaments with a filament tenacity of at least 1.0 N/tex, characterized in that a weight fraction χ of the total weight of synthetic filaments present in the load bearing core have a length L_{F} in the range of 0.01 m to 0.7*L_{R}, wherein said weight fraction is at least 50 wt % and wherein the filaments have a silicone resin or an ethylene crystalline plastomer on their surface. The polymeric resin or the ethylene crystalline plastomer covers at least 50% of the total surface of the synthetic filaments of the lengthy body, preferably 70 and most preferably 90% of the total surface of the synthetic filaments. A rope according to this embodiment may form a tether with optimized rope strength or reeling properties. The filaments at least partially embedded in the matrix will be subject to less internal friction upon the loading and bending of the tether. This is advantageous when tethers are being employed under cyclic load conditions such as airborne wind power generation system comprising a power generating winch as a ground unit. Also in other embodiments of the rope and air born wind power generating systems according to the invention described herein it may be advantageous to use a rope wherein the filaments are at least partially embedded in a matrix, such that they are subject to less internal friction upon the loading and bending of the tether. The polymeric matrix also offers further protection against damage development during dynamic loading conditions for instance and limit the deterioration of properties during long term use. It is observed that tethers comprising such ropes may not need any further components, in other words the ropes may be used as tether as such. In a preferred embodiment, the weight ratio of synthetic filaments to polymeric matrix in the rope is between 100 and 4, preferably between 50 and 5 and most preferably between 40 and 8. Herein weight of synthetic filaments is the total weight of all synthetic filaments defined according to the invention present in the rope and the weight of the polymeric matrix is the total weight of polymeric matrix present in the rope.

In a preferred embodiment of the invention, the rope comprises at least a weight fraction χ of short fibers, i.e. filaments in the range of between 5 cm and 1.0 m. Such fiber length is in contrast to fibers generally known as staple fibers and used in spun yarns well known in the art. These typically have smaller length than the short fibers of the present invention. Preferably the rope of the invention comprises at least a weight fraction χ of short fibers with a length of between 0.05 and 1.0 m, preferably of between 0.10 m and 0.75 m and most preferably of between 0.15 m and 0.5 m. It was observed that such ropes provide tethers with a substantially dampened wave superposition while not showing the strength reduction know for ropes prepared from spun yarns. A specially preferred embodiment of the invention is the use of a weight fraction χ of short fibers in combination with the presence of a polymeric matrix at least partially coating said short fibers as defined further above. It was found that such combination of features provides ropes with optimized properties regarding dampening and strength efficiency based on filament tenacity.

In another aspect the rope according to the invention has a length L_{R} of at least 100 m, comprises a yarn, said yarn comprises synthetic filaments as disclosed herein having a filament tenacity of at least 1.0 N/tex, characterized in that a weight fraction χ of the total weight of synthetic filaments present in the load bearing core of the rope have a length of between 0.05 and 1.0 m, wherein said weight fraction X is at least 50 wt % and wherein the filaments have a silicone resin or an ethylene crystalline plastomer on their surface. In such aspect the filaments preferably have an ethylene crystalline plastomer on their surface. In an aspect of this embodiment the length of the synthetic filaments is from 0.10 m to 0.75 m and preferably from 0.15 m to 0.5 m. In an aspect of this embodiment the polymeric resin or the ethylene crystalline plastomer covers at least 50% of the total surface of the synthetic filaments of the lengthy body, preferably 70 and most preferably 90% of the total surface of the synthetic filaments. In such aspect the filaments preferably have an ethylene crystalline plastomer on their surface.

In a yet preferred embodiment, the rope of the invention is a braided or laid construction of strands comprising the weight fraction, wherein at least 50 wt % of said sub-strands have a length L_{S} of between 5.0 m and 0.7*L_{R}, preferably between 25 m and 0.7*L_{R}, more preferably between 100 m and 0.7*L_{R}, most preferably between 200 m and 0.7*L_{R}. In an alternative embodiment, the rope of the invention is a braided or laid construction of strands, wherein said strands are braided or laid from sub-strands comprising the weight fraction χ of synthetic filaments, wherein at least 50 wt % of said strands have a length L_{SS} of between 5 m and 0.07*L_{R}, preferably between 10 m and 0.07*L_{R}, most preferably between 20 m and 0.7*L_{R}. It is observed that ropes with said preferred length of strands or sub-strands represent commercially attractive rope designs having the above described detrimental behavior to a lesser extent, i.e. show a positive dampening behavior of shockwaves propagating in length direction through the tether rope. The preferred length of strands and sub-strands will be simple to produce and work into ropes according to the invention. The skilled person will be aware of braiding technologies allowing the manufacture of such ropes comprising at least a weight fraction χ of synthetic filaments present therein. Preferably at least 70 wt %, more preferably at least 90 wt % and most preferably at least 95 wt % of the strands or sub-strands have the length L_{S} or L_{SS}, as defined here above. Braided or laid ropes with the herein defined weight percentages and lengths of strands and sub-strands preferably have the characteristics that during their manufacture the strands or sub-strands are respectively introduced to the rope or strand manufacturing process at regular intervals, and ideally when corresponding strands and sub-strands yet present in the rope or strand are ended. In other words, the rope or strands present in the rope according to the invention have a braiding or laying pattern as common ropes or strands known in the art, with the difference that along the length of the rope or strands, the strands or sub-strands forming them are regularly terminate while new strands or sub-strands take their respective position in the rope or strands. Therefor an embodiment of the invention is that the rope comprises strand ends, or sub-strand ends, at regular intervals along the length direction of the rope.

Ropes comprising the high strength filaments may provide ropes with high strength. Therefor the embodiments of the present invention concern rope and tether systems wherein the rope has a tenacity of at least 0.50 N/tex, preferably the rope has a tenacity of at least 0.60 N/tex, more preferably of at least 0.70 N/tex, even more preferably 0.80 N/tex and most preferably at least 1.00 N/tex. In a further embodiment of the invention, the strength member has a tenacity of at least 0.9 N/tex, preferably at least 1.1 N/tex, more preferably at least 1.3 N/tex and most preferably at least 1.5 N/tex.

Preferably the ropes of the invention have high tenacity and high diameters. The combination of these features provides ropes or tethers with a breaking strength, also called minimum break load (MBL) of at least 10 kN, more preferably of at least 50 kN and most preferably of at least 100 kN. The MBL may be obtained by testing according to ISO 2307, whereby the tenacity of the rope is calculated by dividing said MBL by the titer of the rope.

Preferrably the synthetic filaments are filaments manufactured from a polymer chosen from the group consisting of polyamides and polyaramides, e.g. poly(p-phenylene terephthalamide) (known as Kevlar®); poly(tetrafluoroethylene) (PTFE); poly{2,6-diimidazo-[4,5b-4′,5′e]pyridiylene-1,4(2,5-dihydroxy)phenylene} (known as M5); poly(p-phenylene-2,6-benzobisoxazole) (PBO) (known as Zylon®); liquid crystal polymers (LCP); poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyvinyl alcohols; and also polyolefins e.g. homopolymers and copolymers of polyethylene and/or polypropylene. The preferred synthetic filaments are selected from polyaramidefilaments and high or ultra high molecular weight polyethylene (HMWPE or UHMWPE) fibers. Preferably the HMWPE fibers are melt spun and the UHMWPE are gel spun, e.g. fibers manufactured by DSM Dyneema, NL. In an aspect the synthetic filaments are e-PTFE fibers (known as Omnibend®). Liquid crystal polymers (LCP) are known as Vectran®.

In a preferred embodiment, the rope comprises ultra-high molecular weight polyethylene (UHMWPE) filaments, more preferably gel spun UHMWPE filaments. In a further preferred embodiment, at least 50, more preferably at least 80 and even more preferably at least 90 wt % and most preferably all of the synthetic filaments present in the rope are UHMWPE filaments. In an embodiment the rope for a tethered airborne wind power generation system comprises load carrying primary strands comprising yarns, wherein the yarns comprise ultra-high molecular weight polyethylene fibers. In a further embodiment, at least 50, more preferably at least 80 and even more preferably at least 90 wt % and most preferably all of the fibers present in the yarns are UHMWPE fibers.

Preferably the UHMWPE present in the UHMWPE filaments has an intrinsic viscosity (IV) of at least 3 dL/g, more preferably at least 4 dL/g, most preferably at least 5 dL/g. Preferably said IV is at most 40 dL/g, more preferably at most 30 dL/g, more preferably at most 25 dL/g. The IV may be determined according to ASTM D1601(2004) at 135° C. in decalin, the dissolution time being 16 hours, with BHT (Butylated Hydroxy Toluene) as anti-oxidant in an amount of 2 g/l solution, by extrapolating the viscosity as measured at different concentrations to zero concentration. Examples of gel spinning processes for the manufacturing of UHMWPE fibers are described in numerous publications, including WO 01/73173 A1, EP 1,699,954 and in “Advanced Fibre Spinning Technology”, Ed. T. Nakajima, Woodhead Publ. Ltd (1994), ISBN 185573 182 7.

According to a preferred embodiment, the rope and/or the strands are pre-stretched before constructing the tether. This pre-stretching step is preferably performed at elevated temperature but below the melting point of the (lowest melting) filaments in the strands (also called heat-stretching or heat-setting); preferably at temperatures in the range 80-150° C. Such a pre-stretching step is described in EP 398843 B1 or U.S. Pat. No. 5,901,632.

The rope of the invention may have a cross-section that is about circular or round, but also an oblong cross-section, meaning that the cross-section of a tensioned rope shows a flattened, oval, or even (depending on the number of primary strands) an almost rectangular form. Such oblong cross-section preferably has an aspect ratio, i.e. the ratio of the larger to the smaller diameter (or width to thickness ratio), in the range of from 1.2 to 4.0.

In an aspect the cross-section of a tensioned rope herein is the cross section of the rope under a load of 300 MPa.

The rope according to the invention can be of various constructions, including laid, braided, parallel, and wire rope-like constructed ropes. The number of strands in the rope may also vary widely, but is generally at least 3 and preferably at most 16, to arrive at a combination of good performance and ease of manufacture. Preferably the rope of the invention is a braided rope, a laid rope, a parallel strand rope, a soutache braided rope or a parallel fiber rope. In an aspect the rope according to the invention is a soutache braided rope.

In one embodiment the rope according to the invention is of a braided construction, to provide a robust and torque-balanced rope that retains its coherency during use. There is a variety of braid types known, each generally distinguished by the method that forms the rope. Suitable constructions include soutache braids, tubular braids, and flat braids. Tubular or circular braids are the most common braids for rope applications and generally consist of two sets of strands that are intertwined, with different patterns possible. The number of strands in a tubular braid may vary widely. Especially if the number of strands is high, and/or if the strands are relatively thin, the tubular braid may have a hollow core; and the braid may collapse into an oblong shape.

The number of strands in a braided rope according to the invention is preferably at least 3. There is no upper limit to the number of strands, although in practice ropes will generally have no more than 32 strands. Particularly suitable are ropes of an 8- or 12-strand braided construction. Such ropes provide a favourable combination of tenacity and resistance to bend fatigue, and can be made economically on relatively simple machines.

The rope according to the invention can be of a construction wherein the lay length (the length of one turn of a strand in a laid construction) or the braiding period (the pitch length related to the width of a braided rope) is not specifically critical. Suitable lay lengths and braiding periods are in the range of from 4 to 20 times the diameter of the rope. A higher lay length or braiding period may result in a more lose rope having higher strength efficiency, but which is less robust and more difficult to splice. Too low a lay length or braiding period would reduce tenacity too much. Preferably therefore, the lay length or braiding period is about 5-15 times the diameter of the rope, more preferably 6-10 times the diameter of the rope.

The rope according to the invention can be of a construction wherein the braiding period (that is the pitch length related to the width of the rope) or the lay length is not specifically critical; suitable braiding periods and lay length are in the range of from 4 to 20. A higher period or lay length results in a more lose rope having higher strength efficiency, but which is less robust and more difficult to splice. Too low a braiding period would reduce tenacity too much. Preferably therefore, the braiding period is about 5-15, more preferably 6-10.

The rope according to the invention is utmost suitable to be the load bearing core of a tether system for airborne wind power generation systems. The rope can be used for anchoring, and optionally providing an electrical current to or from, a high-altitude wind energy system. The rope is suitable for tethers of high altitude wind energy systems which are provided with a ground generator but also systems wherein the tether transports power from an airborne generator to a ground station. The present invention hence also relates to airborne wind power generation system comprising at least a winch and an airborne unit connected by a tether, wherein the tether comprises the rope according to the invention. In an embodiment of airborne wind power generation system according to the invention, such system comprises a ground station comprising a winch for storing excess length of the tether and a power generator. The winch may be a drum winch or a traction winch combined with a storage winch connected to it. The power generator may be part of the ground station or part of the airborne wind unit. In the latter case a conductive tether will be used to transport the generated energy from the airborne unit to the ground station. The tether of said airborne wind power generation system may comprise at least 2 sections, wherein at least one section comprises the rope according to the invention and a second section comprising a further rope with a circular or oblong cross-section with an aspect ratio of between 1.2 to 4.0, wherein the rope according to the invention is installed to the airborne unit and the further braided rope is installed to the winch. Typically, the 2 sections of the tether are connected via a connector.

In an embodiment, the tether of said airborne wind power generation system comprises at least 2 sections, wherein at least one section comprises the rope according to the invention and a second section comprising a further braided rope with a circular or oblong cross-section with an aspect ratio in the range of 1.2 to 4.0, wherein the aerodynamic braided rope is installed to the airborne unit and the further braided rope is installed to the winch.

The inventor identified that the beneficial properties of the rope stem from the dampening of shockwave propagating and interfering in the longitudinal direction of said rope. As postulated the superposition and amplification of the vibration is a complex interaction of parameters such as vibration frequency, filament dimensions and modulus, rope dimensions and tension in operation. Although an unfavourable set of parameters might be encountered upon static use of the rope in an airborne application, i.e. at a fixed altitude of the airborne unit, it is substantially more likely that the rope is subjected to an unfavourable set of parameters when dynamically operated, i.e. when operated in a cyclic reel-unreel application, such as with ground based power generating unit. Therefor the invention relates also to the use of a rope according to the invention in an airborne wind power generation system according to the invention wherein the length of the rope between the base and the airborne unit oscillates between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.

The present invention includes the following embodiments:
1. A rope having a length L_{R} of at least 100 m, the rope comprising synthetic filaments with a filament tenacity of at least 1.0 N/tex, characterized in that a weight fraction χ of the total weight of synthetic filaments present in the load bearing core have a length L_{F} in the range of 0.01 m to 0.7*L_{R}, wherein said weight fraction is at least 50 wt %.
2. The rope of embodiment 1 wherein the rope is having a length L_{R} of at least 100 m, the rope comprising synthetic filaments with a filament tenacity of at least 1.0 N/tex, characterized in that a weight fraction χ of the total weight of synthetic filaments present in the load bearing core have a length L_{F} of between 0.05 m and 0.7*L_{R}, wherein said weight fraction is at least 50 wt %.
3. The rope of embodiment 1 or 2 wherein said weight fraction is at least 70 wt %, preferably at least 90 wt % more preferably at least 95 wt % and most preferably at least 99 wt %.
4. The rope of any of the embodiments 1 to 3 wherein the rope further comprises a polymeric matrix.
5. The rope of embodiment 4 wherein the weight ratio of synthetic filaments to polymeric matrix in the load bearing core is between 100 and 4, preferably between 50 and 5 and most preferably between 40 and 8.
6. The rope of embodiments 1 to 5 wherein the synthetic filaments of said weight fraction are short fibers with a length L_{F} of between 0.05 and 1.0 m, preferably of between 0.10 m and 0.75 m and most preferably of between 0.15 m and 0.5 m.
7. The rope of embodiments 1 to 5 wherein the rope is a braided or laid construction of strands comprising the weight fraction χ of synthetic filaments, wherein at least 50 wt % of said strands have a length L_{S} of between 5.0 m and 0.7*L_{R}, preferably between 25 m and 0.7*L_{R}, more preferably between 100 m and 0.7*L_{R}, most preferably between 200 m and 0.7*L_{R}.
8. The rope of embodiments 1 to 5 wherein the rope is a braided or laid construction of strands, wherein said strands are braided or laid from sub-strands comprising the weight fraction χ of synthetic filaments, wherein at least 50 wt % of said sub-strands have a length L_{SS} of between 5 m and 0.07*L_{R}, preferably between 10 m and 0.07*L_{R}, most preferably between 20 m and 0.7*L_{R}.
9. The rope of embodiment 7 or 8 wherein at least 70 wt %, preferably at least 90 wt % and most preferably at least 95 wt % of said strands or sub-strands have the length L_{S} or L_{SS}.
10. The rope of embodiments 7 to 9 having a braided or laid construction of strands, whereby the rope comprises strand ends or sub-strand ends at regular intervals along the length direction of the rope.
11. The rope of any of the preceding embodiments wherein the synthetic filaments are selected from the group consisting of polyaramid filaments and ultra-high molecular weight polyethylene (UHMWPE) filaments.
12. The rope of any of the preceding embodiments wherein the filaments have a tenacity of at least 1.5 N/tex, preferably 2.0 N/tex and most preferably 2.5 N/tex.
13. The rope of any of the preceding embodiments having a length of at least 300 m.
14. The rope of any of the preceding embodiments wherein the rope is a braided rope, a laid rope, a parallel strand rope, a soutache braided rope or a parallel fiber rope.
15. The rope of any of the preceding embodiments wherein the rope is a braided rope, a laid rope or a soutache braided rope.
16. The rope of any of the preceding embodiments wherein the rope is a parallel strand rope or a parallel fiber rope.
17. The rope of any of the preceding embodiments wherein the tether is conductive, preferably the tether has electric conductive element inside one of the channels.
18. An airborne wind power generation system comprising at least a winch and an airborne unit connected by a tether, wherein the tether comprises the rope according to any of the preceding embodiments.
19. An airborne wind power generation system comprising a power generator, a tether according any preceding embodiment, a ground station comprising a winch, whereby the tether is connecting the air born unit and the winch.
20. An airborne wind power generation system according to any preceding embodiment wherein the winch is a drum or a traction winch combined with a storage winch connected to it, for storing excess length of the tether.
21. An airborne wind power generation system according to any preceding embodiment wherein the power generator is part of the ground station.
22. An airborne wind power generation system according to any preceding embodiment wherein the power generator is part of the airborne wind unit and the tether is a conductive tether suitable for transporting the generated energy from the airborne unit to the ground station.
23. The airborne wind power generation system according any preceding embodiment, wherein airborne unit is selected from a kite, a balloon, an airplane or a drone.
24. The airborne wind power generation system according to embodiment 17 or 18, wherein the winch is a reeling winch.
25. The airborne wind power generation system according to any preceding embodiment, wherein the rope has an oblong cross-section, preferably the oblong cross section has an aspect ratio in the range of from 1.2 to 4.0, wherein the aspect ratio is the ratio of the larger to the smaller diameter.
26. The airborne wind power generation system according to any preceding embodiment, wherein the rope has an oblong cross-section, preferably the oblong cross section has an aspect ratio in the range of from 1.2 to 4.0, wherein the aspect ratio is the width to thickness ratio.
27. The airborne wind power generation system according to any preceding embodiment, wherein the tether comprises a load bearing rope according to any preceding embodiment to anchor the airborne unit to an anchoring point, preferably the anchoring point is connected to the ground, the desk of a ship, an off-shore platform or a sea bed.
28. The airborne wind power generation system according to any preceding embodiment, wherein the tether comprises at least 2 sections, wherein a first section comprises the rope according to any one of the preceding embodiments and a second section comprises a further rope with a circular or oblong cross-section with an aspect ratio of between 1.2 to 4.0, wherein the rope according to any one of the preceding embodiments is installed to the airborne unit and the further braided rope is installed to the winch and the first and second section are connected via a connector such that the winch and airborne unit are connected.
29. The airborne wind power generation system according to any preceding embodiment, wherein the length of the rope between winch and the airborne unit is in the range of 100 m to 10,000 m
30. The airborne wind power generation system according to any preceding embodiment, wherein the length of the rope between the winch and the airborne unit is such that it allows for oscillation between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.
31. The use of a rope according to any of the preceding embodiments in an airborne wind power generation system according to any preceding embodiments wherein the length of the rope between the base and the airborne unit oscillates between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.
32. The use of a rope according to any of the preceding embodiments in an airborne wind power generation system according to any preceding embodiment, wherein the length of the rope between the winch and the airborne unit oscillates between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.
33. The use of a rope according to any of the preceding embodiments as load bearing core of a tether cable for a tethered airborne wind power generation system.
34. The use according to any of the preceding embodiments wherein the airborne wind power generation system is dynamically operated.
35. The use according to any of the preceding embodiments wherein the airborne wind power generation system is operated in a cyclic reel-unreel application.
36. The use according to any of the preceding embodiments, wherein the base is a ground based power generating unit.
37. The use according to any of the preceding embodiments wherein the tether comprises a load bearing rope according to any preceding embodiment to anchor the system to an anchoring point, preferably the anchoring point is the ground or a sea bed.
38. The use according to any of the preceding embodiments wherein the tether comprises at least 2 sections, wherein at least one section comprises the rope according to any one of embodiments and a second section comprising a further rope with a circular or oblong cross-section with an aspect ratio of between 1.2 to 4.0, wherein the rope according to any one of embodiments . . . is installed to the airborne unit and the further braided rope is installed to the winch.
39. The use according to any of the preceding embodiments, wherein the length of the rope between a base comprising a winch and the airborne unit oscillates between a maximum length Lₘₐₓ and a minimum length Lₘᵢₙ, wherein Lₘₐₓ is at most 8,000 m and Lₘᵢₙ is at least 150 m and wherein the ratio of Lₘₐₓ to Lₘᵢₙ is between 10 and 1.5.
40. The use according to any of the preceding embodiments, wherein the length of the rope between a base comprising a winch and the airborne unit oscillates between a maximum length Lₘₐₓ and a minimum length Lₘᵢₙ, wherein Lₘₐₓ is at most 1000 m and Lₘᵢₙ is at least 50 m and wherein the ratio of Lₘₐₓ to Lₘᵢₙ is between 10 and 1.5.
41. The use according to any of the preceding embodiments, wherein the length of the rope between a ground station comprising a winch and the airborne unit oscillates between a maximum length Lₘₐₓ and a minimum length Lₘᵢₙ, wherein Lₘₐₓ is at most 8,000 m and Lₘᵢₙ is at least 150 m and wherein the ratio of Lₘₐₓ to Lₘᵢₙ is between 10 and 1.5.
42. The use according to any of the preceding embodiments, wherein the length of the rope between a ground station comprising a winch and the airborne unit oscillates between a maximum length Lₘₐₓ and a minimum length Lₘᵢₙ, wherein Lₘₐₓ is at most 1000 m and Lₘᵢₙ is at least 50 m and wherein the ratio of Lₘₐₓ to Lₘᵢₙ is between 10 and 1.5.

### FIGURE DESCRIPTION

FIG. 1 schematically depicts an embodiment of airborne wind power generation system according to the invention comprising a winch (3) and an airborne unit (4) connected by a tether (2), wherein the tether comprises the rope (1) according to the invention. The winch (3) is part of a ground station (5). The ground station is connected to the ground, the deck of a ship, typically the bow of the ship, an off shore platform of a sea bed (collectively referred to as 6)

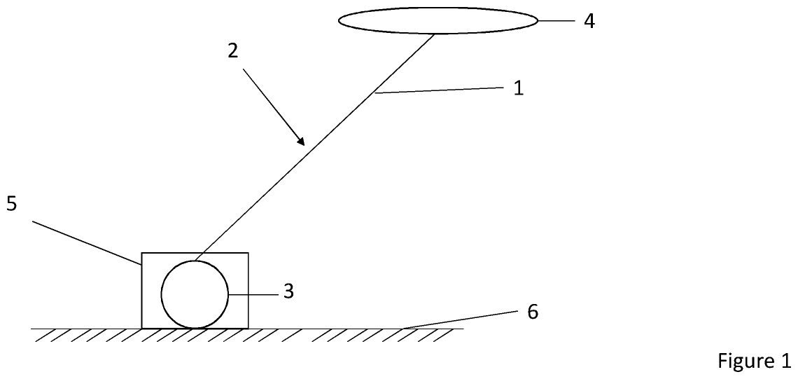

FIG. 2 schematically depicts an embodiment of the rope according to the invention. The rope (1) has a length L_{R}, and comprises synthetic filaments (10) having a length L_{F}. The length L_{R} is defined as the distance between the winch (3) and the air born unit. (4). During operation L_{R} varies between Lmin and Lmax, i.e. between a maximum length Lₘₐₓ and a minimum length Lₘᵢₙ, wherein Lₘₐₓ is at most 10,000 m and Lₘᵢₙ is at least 100 m and wherein the ratio of Lₘₐₓ to Lₘᵢₙ is between 10 and 1.5.

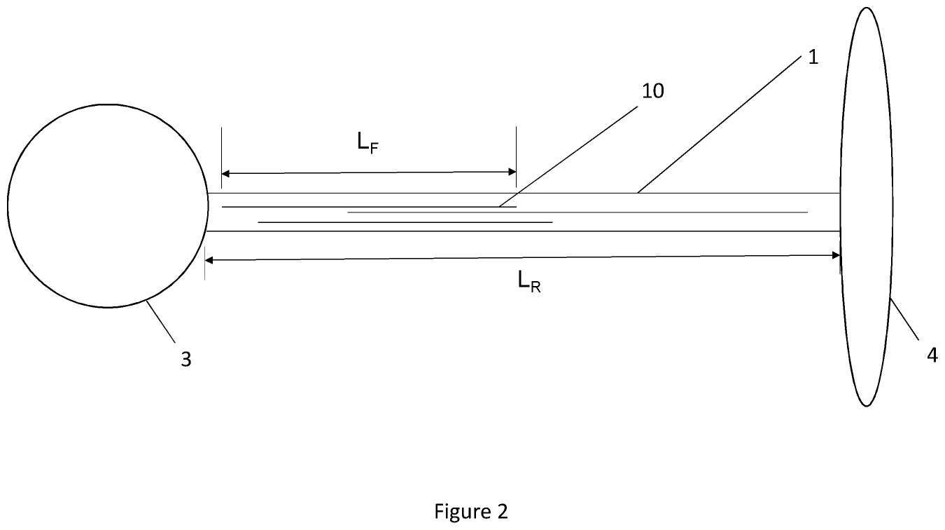

FIG. 3 schematically depicts an embodiment of the airborne wind power generation system according to the invention. In this embodiment the tether (2) comprises at least 2 sections, wherein a first section (8) comprises the rope according to the invention and a second section (9) comprises a further rope with an oblong cross-section with an aspect ratio of between 1.2 to 4.0. The rope according to the invention (8) is installed to the airborne unit (4) and the further braided rope (9) is installed to the winch (3) and the first (8) and second section (9) are connected via a connector (7) such that the winch and airborne unit are connected.

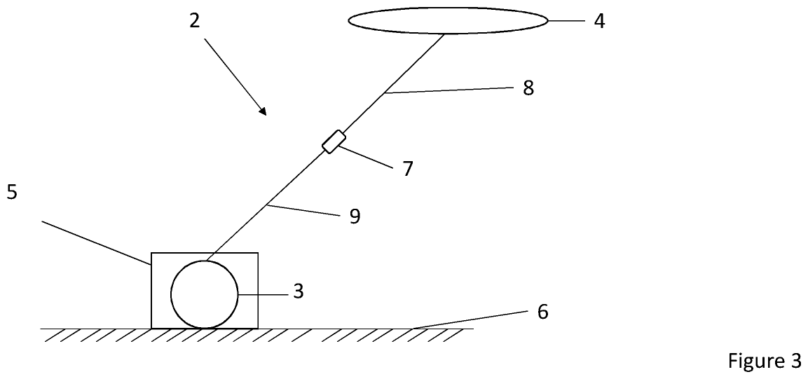

FIG. 4 schematically depicts a cross section of a further braided rope (9) with an oblong cross-section having a larger diameter (D) (or width) and a smaller diameter (d) (or thickness). The oblong cross-section preferably has an aspect ratio, i.e. the ratio of the larger to the smaller diameter (or width to thickness ratio), in the range of from 1.2 to 4.0.

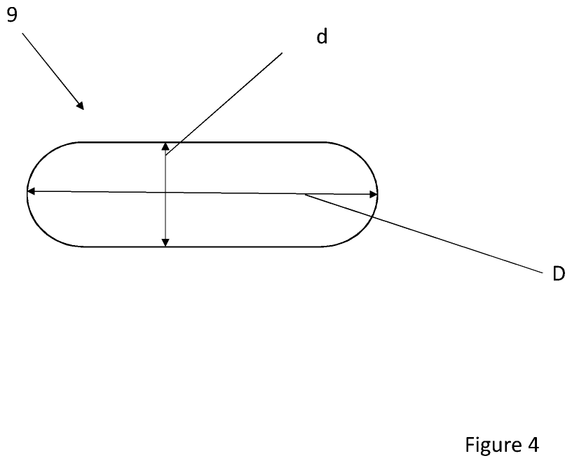

1-15. (canceled)

16. A rope having a length L_{R} of at least 100 m, the rope comprising synthetic filaments with a filament tenacity of at least 1.0 N/tex, wherein a weight fraction χ of the total weight of synthetic filaments present in a load bearing core have a length L_{F} of 0.01 m to 0.7*L_{R}, and wherein said weight fraction is at least 50 wt %.

17. The rope according to claim 16, wherein said weight fraction is at least 70 wt %.

18. The rope according to claim 16, wherein the rope further comprises a polymeric matrix.

19. The rope according to claim 18, wherein the weight ratio of synthetic filaments to polymeric matrix in the load bearing core is between 100 and 4.

20. The rope according to claim 16, wherein the synthetic filaments of said weight fraction are short fibers with a length L_{F} of between 0.05 and 1.0 m.

21. The rope according to claim 16, wherein the rope is a braided or laid construction of strands comprising the weight fraction χ of synthetic filaments, wherein at least 50 wt % of said strands have a length L_{S} of between 5.0 m and 0.7*LR.

22. The rope according to claim 16, wherein the rope is a braided or laid construction of strands, wherein said strands are braided or laid from sub-strands comprising the weight fraction χ of synthetic filaments, wherein at least 50 wt % of said sub strands have a length L_{SS} of between 5 m and 0.07*LR.

23. The rope according to claim 21, wherein at least 70 wt % of said strands or sub-strands have the length L_{S}.

24. The rope according to claim 22, wherein at least 70% of said strands or sub-strands have the length L_{SS}.

25. The rope according to claim 21 wherein the rope comprises a braided or laid construction of strands, and wherein the rope comprises strand ends or sub-strand ends at regular intervals along a length direction of the rope.

26. The rope according to claim 22, wherein the rope comprises a braided or laid construction of strands, and wherein the rope comprises strand ends or sub-strand ends at regular intervals along a length direction of the rope.

27. The rope according to claim 23, wherein the rope comprises a braided or laid construction of strands, and wherein the rope comprises strand ends or sub-strand ends at regular intervals along a length direction of the rope.

28. The rope according to claim 24, wherein the rope comprises a braided or laid construction of strands, and wherein the rope comprises strand ends or sub-strand ends at regular intervals along a length direction of the rope.

29. The rope according to claim 16, wherein the synthetic filaments are selected from the group consisting of polyaramid filaments and ultra-high molecular weight polyethylene (UHMWPE) filaments.

30. The rope according to claim 16, wherein the filaments have a tenacity of at least 1.5 N/tex.

31. The rope according to claim 16, wherein the rope has a length of at least 300 m.

32. The rope according to claim 16, wherein the rope is a braided rope, a laid rope, a parallel strand rope, a soutache braided rope or a parallel fiber rope.

33. An airborne wind power generation system comprising at least a winch and an airborne unit connected by a tether, wherein the tether comprises the rope according to claim 16.

34. The airborne wind power generation system according to claim 33, wherein the length of the rope measured between a base and the airborne unit oscillates between a maximum length Lₘₐₓ and a minimum length Lₘₘ, wherein Lₘₐₓ is at most 10,000 m and Lₘₘ is at least 100 m, and wherein the ratio of Lₘₐₓ to Lₘₘ is between 10 and 1.5.
